(19) United States
(12) Patent Application Publication
(10) Pub. No.: US 2013/0325502 A1
(43) Pub. Date: Dec. 5, 2013

(54) SYSTEM AND METHOD FOR PROVIDING SYNDROME-SPECIFIC, WEIGHTED-INCIDENCE TREATMENT REGIMEN RECOMMENDATIONS

(71) Applicants: Ari Robicsek, Skokie, IL (US); Courtney Hebert, Columbus, OH (US); Eric C. Brown, Evanston, IL (US)

(72) Inventors: Ari Robicsek, Skokie, IL (US); Courtney Hebert, Columbus, OH (US); Eric C. Brown, Evanston, IL (US)

(21) Appl. No.: 13/489,082

(22) Filed: Jun. 5, 2012

(51) Int. Cl. G06Q 50/24

(52) U.S. Cl. 705/3

(57) ABSTRACT

A system and method for guiding the selection of treatment regimens according to locality-specific and patient-specific criteria. The system and method may employ a guidance engine that determines past efficacies of multiple treatment regimens in prior patients presenting with the syndrome of interest in a given locality, then correlate those outcomes with the clinical and demographic characteristics of the prior patients and locality. The guidance engine determines the influence of multiple patient characteristics and locality trends on positive treatment outcomes, and uses such determinations to generate a report including success probabilities for various treatment regimens, given the current patient's particular characteristics and trends within the patient's current locality. The system and method may be implemented in a variety of embodiments, including via a networked system interfaced with a healthcare facility's electronic medical record system, or as a stand-alone device.

### BACKGROUND OF THE INVENTION

The field of the invention is medical information systems and methods for their use. More particularly, the invention relates to a system and method for providing treatment regimen recommendations to a user relating to a specific syndrome, based on weighted-incidence historical and patient-specific data.

In general, current systems and methods for guiding the selection of antibiotics and other similar treatments for infected patients are based on a correlation between specific antibiotics or other drugs and particular microorganisms. These systems and methods can indicate to a clinician the efficacy of specific antibiotics or other drugs at combating particular microorganisms. In other words, current systems and methods are not syndrome-specific, infection-specific, or disease-specific, but rather simply indicate which drugs are effective at treating which microorganisms (bacteria, etc.). Stated another way, current systems and methods indicate the microorganisms that are susceptible or resistant to specific antibiotics or other drugs, but leave it to the clinician to make various assumptions regarding which microorganism or microorganisms might be causing an infection and which antibiotic or antibiotic regimen is most appropriate.

One common system used in indicating susceptibility information is the “antibiogram,” which indicates the relationship between specific antibiotics and specific microorganisms. By way of illustration, and without admission that the content is prior art, FIG. 1 depicts an example of the framework for how antibiograms are assembled and used. The antibiogram 10 is a chart in which each row 12 correlates to a particular drug and each column 14 correlates to a particular microorganism. The content of the chart 10 displays the probability that a particular microorganism in one of the classes of microorganisms displayed in the columns 14 will be susceptible to one of the drugs displayed in each row 12. For example, the row for Ciprofloxacin 18 shows that there is a 0% likelihood that a microorganism in the “Enterococcus species” will be susceptible to Ciprofloxacin, a 67% likelihood that a microorganism in the “Escherichia coli” family would be susceptible to Ciprofloxacin, and so forth.

Antibiograms such as this are developed by a particular lab and are generally published periodically, such as annually, based on pathological information. In this regard, such antibiograms are backward looking and rely on data made available to labs over the course of data collection for pathological analysis other than creating an antibiogram. That is, not only is the data backward looking, but the labs are not provided data specifically for the purpose of creating antibiograms. Rather, the labs typically compile data for antibiograms from samples and information provided to the lab for other pathological analysis.

Also, choosing an antibiotic or antibiotics for an infected patient at the time of diagnosis using an antibiogram can be challenging because culture results which would more definitively indicate which microorganisms are likely causing an infection are not available at the time of initial diagnosis, and generally are not available for several days. Clinicians are therefore required to choose antibiotics based on their best guess about which organism or organisms are the infecting organism(s), and to which antibiotics the organism(s) will be susceptible. This guesswork is a critical factor in several potential outcomes. A clinician's guess as to which antibiotic to use prior to culture results may result in undertreatment (i.e. not treating with an antibiotic or antibiotics that sufficiently cover the scope of organism causing the disease or infection). Or, a clinician's guess may lead to overtreatment (i.e. treating with an overly broad spectrum regimen) which can result in eliminating too many types of organisms and/or can unnecessarily drive up costs and antibiotic resistance.

Therefore, at present, a clinician's best guess at selecting a treatment regimen is based on limited, generalized, or anecdotal knowledge of which organisms may cause certain infections or diseases, combined with guidelines subsumed in current systems and methods that are not syndrome-specific or infection-specific. Antibiograms, for example, do not indicate which organisms need to be covered in treating a given infection. They are only truly useful if a clinician knows which organisms need to be treated—information a clinician will not yet know at the time of initial diagnosis, when a treatment selection must be made. Furthermore, traditional antibiograms only indicate the overall resistance or susceptibility of an organism to a drug based on data available to a given lab or organization that are not syndrome-specific. Thus, for example, an antibiogram might indicate that, overall, 20% of E. coli bacteria are resistant to fluoroquinolones, but would not indicate whether and to what extent this resistance percentage varies between urinary and respiratory isolates.

Another problem with current methods for guiding treatment selection is that they do not reflect local or regional epidemiology, let alone “institutional” trends, such as showing rates of antibiotic resistance among various bacteria isolated at a particular hospital or center. Antibiograms are sometimes developed based on national surveys or test results because of the high cost in creating them. In other words, more localized antibiograms are usually not made because they simply do not justify the cost to specific institutions or clusters of institutions. Therefore, because such methods do not reflect localized trends, they provide information that is necessarily less accurate for a given institution. Additionally, antibiograms are usually published only annually, and are thus outdated almost immediately given the rapid nature of changes in antibiotic resistance patterns.

Furthermore, current systems and methods for guiding drug or antibiotic selection do not provide information regarding treatment regimens, such as using multiple antibiotics together. Rather, as can be seen in FIG. 1, current systems such as antibiograms only show the likely effectiveness of individual drugs against individual microorganisms or classes of microorganisms. As clinicians will appreciate, however, specific infections almost invariably will involve multiple causative organisms, and a given patient's infection may involve organisms that may not be known to be correlated to a specific infection. Thus, to properly treat an infection or disease (the diagnosis of which is the only information a clinician has at the time a treatment selection must be made) clinicians are forced to guess in selecting treatment regimens to cover multiple possible causative organisms. Moreover, antibiograms as shown in FIG. 1 do not indicate whether, for example, the 35% probability that one drug would cover one microorganism would be cumulative of or complement the 65% probability that another drug would cover the same microorganism, providing no clarity about whether treating with the two antibiotics would be better than using the ‘65% coverage’ antibiotic alone for this organism. In other words, based solely on an antibiogram, a clinician might prescribe two drugs, one with a 65% probability of covering an organism and one with a 35% probability of covering the same organism, and the two drugs still would not treat the organism (because the ‘35% coverage’ antibiotic may not cover any of the organisms missed by ‘65% coverage’ antibiotic, leading to no advantage of using both antibiotics).

In a related sense, the little guidance that can be offered by antibiograms is even less helpful in selecting treatment for a specific patient's diagnosis because antibiograms do not reflect any patient-specific characteristics. The aggregated antibiotic resistance data shown in antibiograms is drawn from thousands of heterogeneous patients, and says little about the likely resistance in a given patient, given their specific infection and personal characteristics.

Therefore, it would be desirable to have a new system and method for providing guidance to clinicians in selecting treatment regimens that overcomes the aforementioned drawbacks of current systems and methods. In doing so, it would be desirable for such a system and method to adopt a framework that correlates treatments to specific syndromes, contemplates the use and efficacy of combining multiple drugs or antibiotics, is easily updatable, and takes into account local trends and patient-specific characteristics.

### SUMMARY OF THE INVENTION

The present invention overcomes the aforementioned drawbacks by providing a system that includes a treatment regimen guidance system that includes an interface tool configured to receive a diagnosis for a current patient and arranged to communicate the diagnosis and demographic and clinical information regarding the current patient. The system also includes a guidance engine configured to receive the diagnosis and the demographic and clinical information regarding the current patient, wherein the guidance engine is configured to calculate a treatment regimen outcome probability using the demographic and clinical information and at least one predictive model. The interface tool is configured to display to a user an indication of the treatment regimen outcome probability.

It is an aspect of the invention to provide a computer-readable storage medium having stored thereon a computer program that, when executed by a computer processor, causes the computer processor to receive patient characteristic data for a current patient and receive a diagnosis for the current patient. The computer processor is further caused to identify, based on weighted patient-specific and syndrome-specific data for previous patients, at least one treatment regimen that could cover the diagnosis for the subject patient. The computer processor is also caused to calculate a probability that the at least one treatment regimen will successfully treat the diagnosis for the subject patient and generate a report indicating the at least one treatment regimen to a user.

It is another aspect of the invention to provide a computer-readable storage medium having stored thereon a computer program that, when executed by a computer processor, causes the computer processor to implement a treatment regimen guidance system by obtaining and storing characteristics regarding prior incidences of a syndrome of interest within a locality of interest via an electronic medical record system. The computer processor is further caused to implement the treatment regimen guidance system by determining outcomes of combinations of treatments on the syndrome of interest, generating models indicating influences of the characteristics on the outcomes of the combinations of treatments, and storing the models for use in determining probabilities that a combination of treatments will successfully treat the syndrome of interest in a patient.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a chart illustrating an exemplary antibiogram;

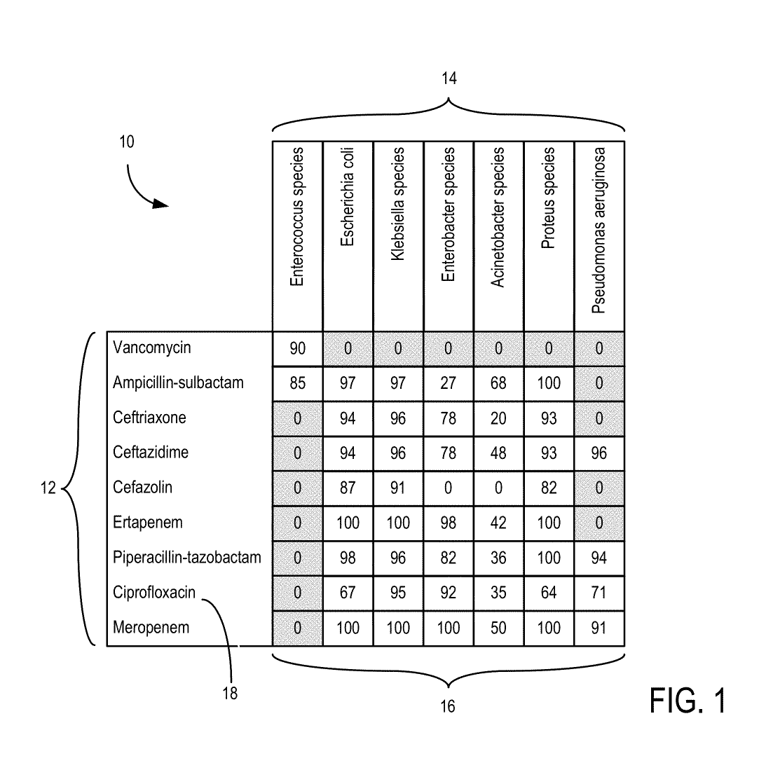

FIG. 2 is a flow chart illustrating the steps of a method for preparing a framework to be used in systems and methods according to the present invention;

FIG. 3 is a chart illustrating a dataset to be used in accordance with one embodiment of the present invention;

FIG. 4 is a chart illustrating a dataset to be used in accordance with one embodiment of the present invention;

FIG. 5 is a chart illustrating a dataset to be used in accordance with one embodiment of the present invention;

FIG. 6 is a chart illustrating a dataset to be used in accordance with one embodiment of the present invention;

FIG. 7 is a diagram of one implementation of a user interface in accordance with the present invention; and

FIG. 8 is a functional block diagram of one embodiment of a guidance system in accordance with the present invention.

### DETAILED DESCRIPTION OF THE INVENTION

As noted above, one aspect of the present invention is to provide a reconceptualized system and method for guiding the selection of drugs and other treatments. The system and method are based on a guidance engine that is syndrome-centric, locality-centric, and patient-centric, in comparison to existing systems and methods which do not differentiate based on syndrome-, patient-, or locality-specific information. In more colloquial terms, this aspect of the invention replaces prior systems which answered the question “will this drug work for this bug?” with a system and method that answer the question “will this treatment regimen work for this particular syndrome, in this particular patient, at this particular hospital?” As any clinician will recognize, the latter question can be far more relevant to making patient treatment decisions. Systems and methods of the present invention therefore present a tool by which clinicians can obtain syndrome-, patient- and locality-customized probabilities that various treatment regimens will successfully treat a given syndrome of interest in a given patient.

This reconceptualization is achieved, in part, by utilizing historical data from a given locality regarding previous patients who have presented with the syndrome of interest (including demographics, clinical history, positive culture information and drug susceptibilities) and modeling probabilities of drug regimen coverage by correlating positive drug susceptibility outcomes with various patient-specific characteristics and weighting the likelihood of a given drug regimen covering the syndrome in a given patient based on those correlations. The modeling may then be loaded into a guidance engine for providing recommendations and other data to clinicians via a therapeutic probability tool. Further steps, features, and aspects will be described herein.

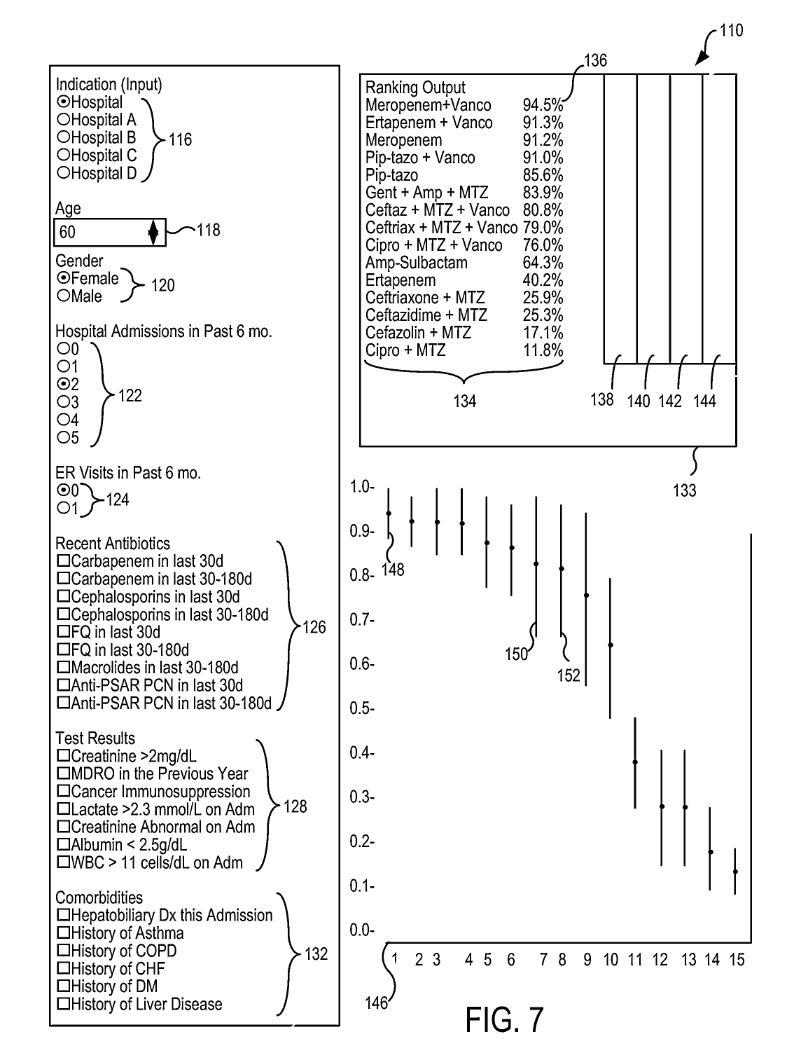

First, to provide context for the description below of how a guidance engine in accordance with the present invention is developed and operates, one exemplary implementation of the present system and method will be briefly described. In the implementation illustrated in FIG. 7, an example of a therapeutic probability tool 110 provides treatment regimen guidance, determined in accordance with aspects of the present invention. The therapeutic probability tool 110 is employed to permit a user to access the logic in a guidance engine created according to the present invention. A user may the tool 110 to input various characteristics or indicators of a given patient or a given locality that are relevant to treatment selection for that patient's infection. For example, the user may input the hospital 116 at which the patient is being treated, the patient's age 118, the patient's gender 120, the number of times the patient has been admitted to a hospital in the past six months 122, whether the patient has visited the emergency room in the past six months 124, the particular antibiotics 126 that have recently been prescribed for the patient, the results of various tests of particular interest 128, and the presence of various co-morbidities 132. By way of example, the box for “MDRO” (Multi-Drug Resistant Organism) in the Previous Year 130 has been checked.

As each Indicator is inputted via window 114, the Ranking Output display 133 and graph 146 are refreshed and updated. The Ranking Output display window 133 contains a list of antibiotic combinations 134 (i.e., treatment regimens), and shows the probability that each combination would successfully treat the patient's ABI. In the example shown, given the patient's particular indicators 116-132, the therapeutic probability tool 110 displays that a treatment regimen of Meropenem combined with Vancomycin 136 would have the highest likelihood of successfully treating the patient's infection at 94.5%. As will be discussed below, these probabilities are determined by the treatment guidance engine disclosed herein.

In the implementation shown in FIG. 7, the Ranking Output display window 133 may also contain a variety of other customizable information. For example, the window 133 may contain indications 138 for each drug combination concerning whether the drugs are covered by the patient's insurance, indications 140 concerning whether the drugs are available and/or preferred within the healthcare system treating the patient, a ranking 142 of how each drug combination fits within a healthcare systems' antibiotic stewardship program (in other words, whether the antibiotics are broad or narrow spectrum), and indications 144 of whether each antibiotic is available in generic versions 144. One skilled in the art will appreciate that such information concerning antibiotics may be customized to include more or less information than is shown in FIG. 7, such as side effects and other medical information regarding each medication and each regimen or contra-indications for certain treatments or medical information (e.g., risks associated with use of certain anti-fungals for persons in the current patient's demographic).

The Ranking Output graph 146 provides further information to a user concerning the range of probabilities of coverage (i.e., the “+/−”) for each antibiotic combination shown in the Ranking Output display window 133. Similarly, for purposes of comparison by the clinician, the Ranking Output display window 133 and/or graph 146 may provide raw probabilities that the regimens 134 would be successful without taking into account the current patient's particular characteristics. For example, the Ranking Output display window 133 could indicate that 70% of all patients with a urinary tract infection would be fully covered by a regimen including a fluoroquinolone and Vancomycin, but that 90% of patients with the same or similar characteristics as the current patient would be fully covered by the same regimen.

Next, a method for preparing a background framework for implementing a guidance engine to drive the tool 110 of FIG. 7 will be explained. For purposes of discussion, an embodiment specific to one type of infection (ABI) will be explained, followed by a discussion of how the framework is implemented into a guidance engine and how the system operates as a whole. Then, various adaptations and alternatives will be described with respect to how the reconceptualized framework and guidance system are used for other syndromes.

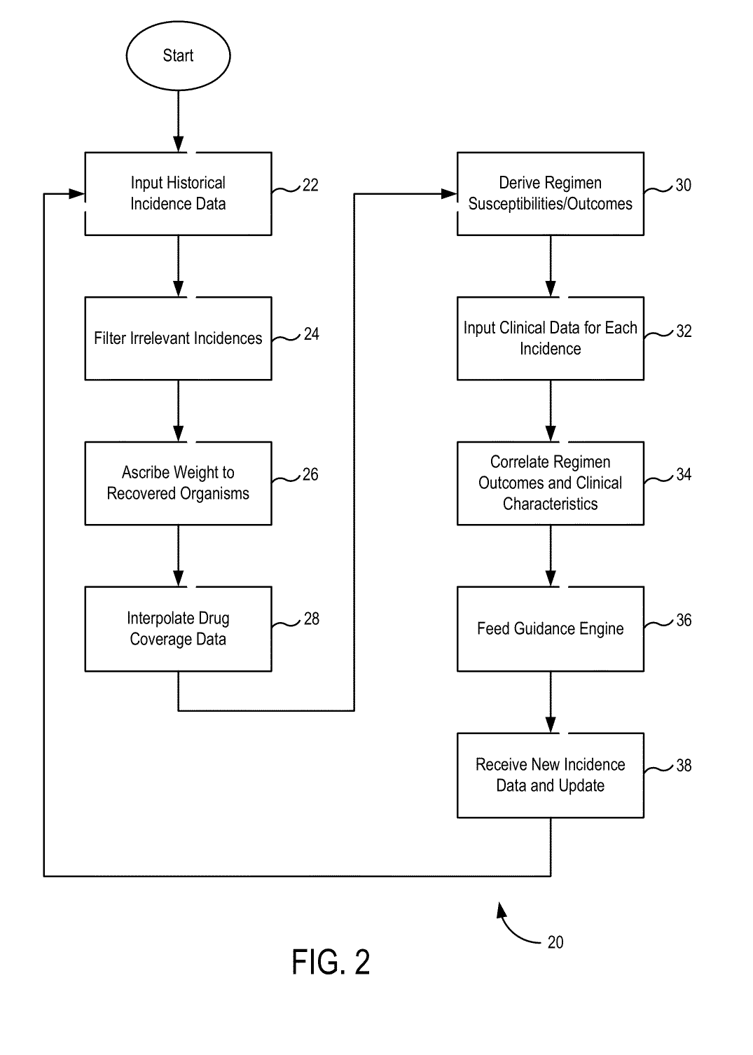

With particular reference to FIG. 2, an illustrative method 20 is described for generating the framework for a system that provides guidance on the selection of drugs and other treatments in accordance with the principles discussed above. For purposes of illustration, the method 20 describes the steps that were undertaken by the inventors in one experiment concerning a drug selection guidance system for abdominal biliary infection (ABI). As will be explained below, however, the method 20 may also apply to other syndromes and certain steps within the exemplary method may be combined, reordered, or eliminated.

This illustrative method 20 begins at the step 22 of inputting historical incidence data. In this inputting step 22, data is gathered from a selected locality regarding all available recorded incidences of a selected syndrome within that locality. The locality may be a specific hospital, a hospital system, all medical centers within a specific geographic region (such as a city, county, state, etc.), or any other desired facility or combination of facilities. The selected syndrome may be any infection or other disease for which drug or other treatment susceptibility or efficacy information is kept or available. For example, the syndrome may be various forms of cancer, infections, cellular traits or genetic conditions, or other diseases or syndromes.

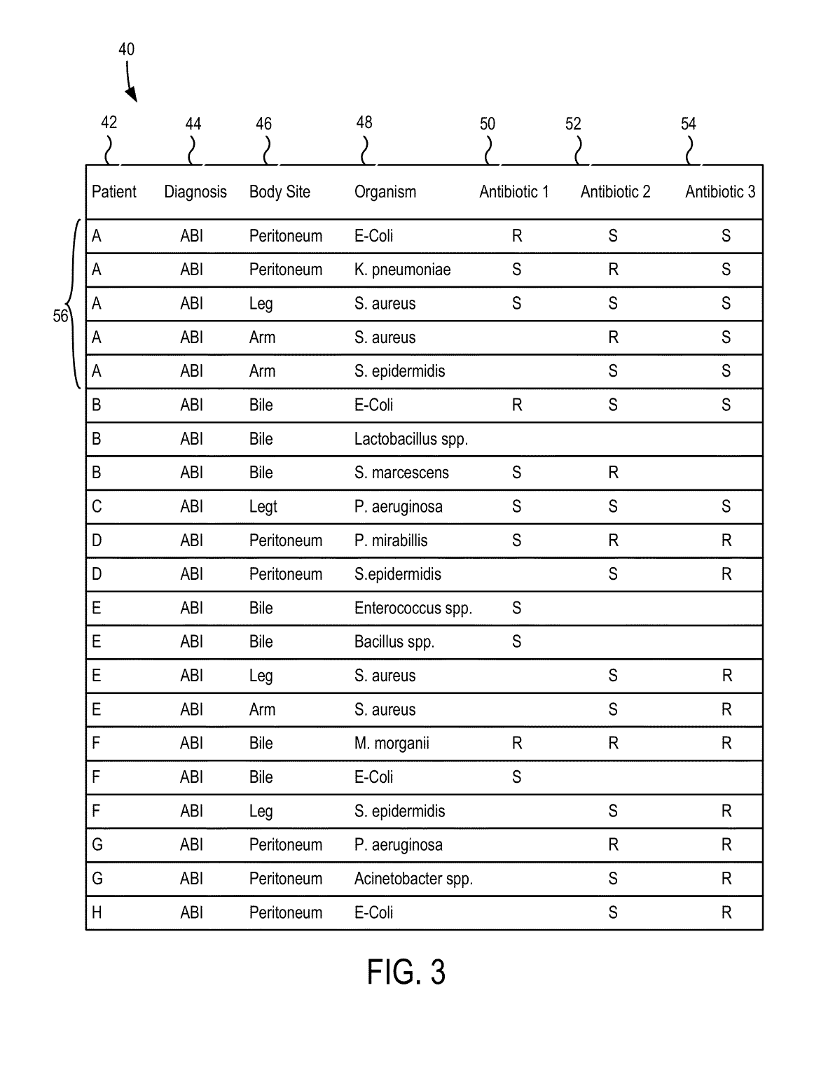

Referring briefly to FIG. 3, an exemplary dataset 40 is shown that would result from the input step 22 of the preparation method 20 shown in FIG. 2. As shown in FIG. 3, the data that is gathered includes indications of each previous patient that had the selected infection 42 (i.e., ABI), the body site 46 at which the infection was diagnosed, the organisms 48 that were recovered and identified from the infection, and the determined resistance R or susceptibility S of each organism 48 to a number of antibiotics 50-54. Moreover, for each patient A-H, a record (as shown, a row) is included in the dataset for each recovered organism 48. Thus, for patient A, five rows 56 are shown, each indicating a different body site and organism combination (e.g., “Peritoneum” and “E. coli”) as well as the determined antibiotic resistance and susceptibility 50-54.

In a preferred embodiment, this information may be obtained directly through interfacing with a hospital system's standard electronic medical record (EMR) system or Laboratory Information System (LIS). As will be described below, this may be achieved via an EMR or network plug-in, or other similar software interfaces. For example, in one experiment, the inventors obtained information regarding approximately 1,000 unique prior incidences of ABI directly from the electronic health record system of a large healthcare system by isolating records having a final diagnosis code consistent with ABI. Eligible patients were those admitted to a hospital within the healthcare system during a certain time period who had a final diagnosis code consistent with ABI and had a positive culture from the primary infection site collected on day one through day four of hospitalization. A record was created for each organism identified in a positive culture in the patient's microbiology file, and patient demographic and clinical characteristics were populated into each record from the patient's electronic medical chart. In other embodiments, the information may be obtained through manual data entry, or via a customized script or other program that mines the data from such electronic systems.

Returning to FIG. 2, the next step 24 in the illustrative method 20 is filtering irrelevant incidence information from the data collected in step 22. In this step, historical data from incidences of the syndrome or infection of interest (e.g., ABI) is filtered to cull records that are unnecessary, undesirable, and/or inappropriate for purposes of comparison to the current patient and that patient's specific syndrome or infection. Alternatively, in some embodiments, step 24 may be partially or completely replaced by employing logic in the initial data input step 22 to permit the collection of only the incidence data of relevance to the framework and specific syndrome of interest.

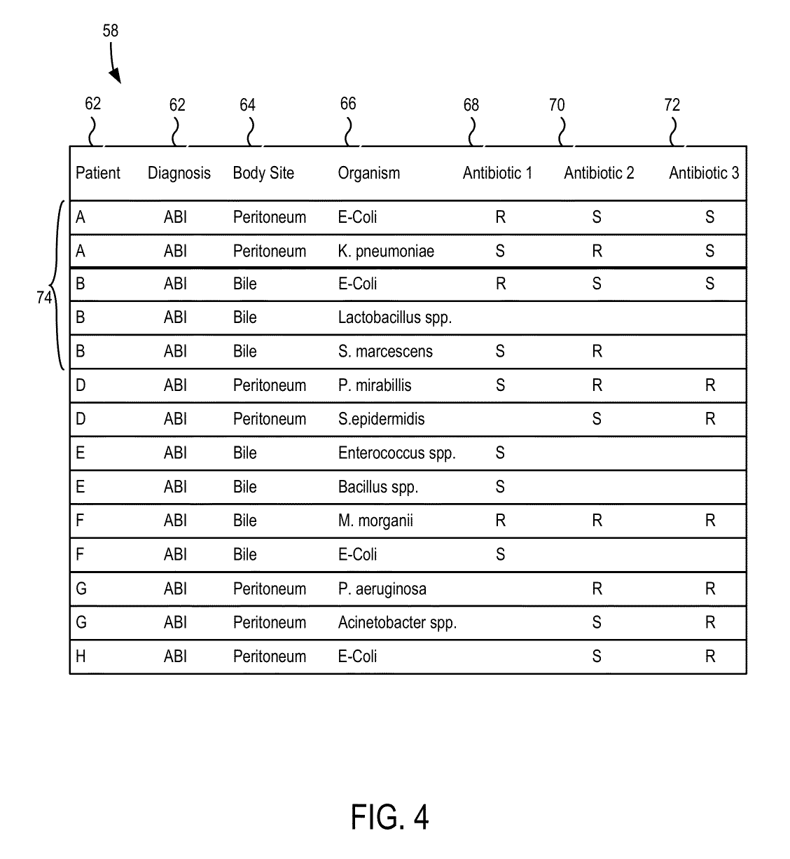

For example, FIG. 4 depicts a dataset 58 illustrating the result of performing the filtering step on the dataset 40 of FIG. 3. As can be seen, the columns of information 60-72 remain the same, but certain records have been excluded. With respect to Patient A, for example, only two rows 74 remain in the dataset 58. Those rows 74 relate to organisms 66 which were recovered only from the patient's Peritoneum. In contrast, in FIG. 3, rows 56 existed for all organisms 48 recovered from a variety of Body Sites 46. However, for a diagnosis of ABI, organisms recovered from a patient's arm or leg would not be clinically relevant to the ABI diagnosis. Thus, in FIG. 4, only those rows 74 which contain information regarding Organisms 66 recovered from relevant Body Sites 64 (e.g., the Peritoneum or Bile) remain. Moreover, FIG. 4 no longer contains any information for Patient C, as there was no information for that patient regarding organisms recovered from Body Sites relevant to the ABI diagnosis. Thus, it would be unnecessary to compare Patient C's historical data to a current patient's specific syndrome and characteristics for diagnostic purposes.

As will be described below, to effectuate this filtering step 24, a server or other computer receiving the data 40 obtained in step 22 can process each patient record and remove irrelevant or undesirable information according to pre-set or user-defined input. For example, a user may set specific criteria for a specific syndrome or class of syndromes such as to exclude certain Body Sites or to include only certain Body Sites. Alternatively, a commercial or institutional provider of the system and method described herein could determine and implement pre-set criteria or rules for the filtering step 24 and/or for the input step 22 according to known medical diagnostic information.

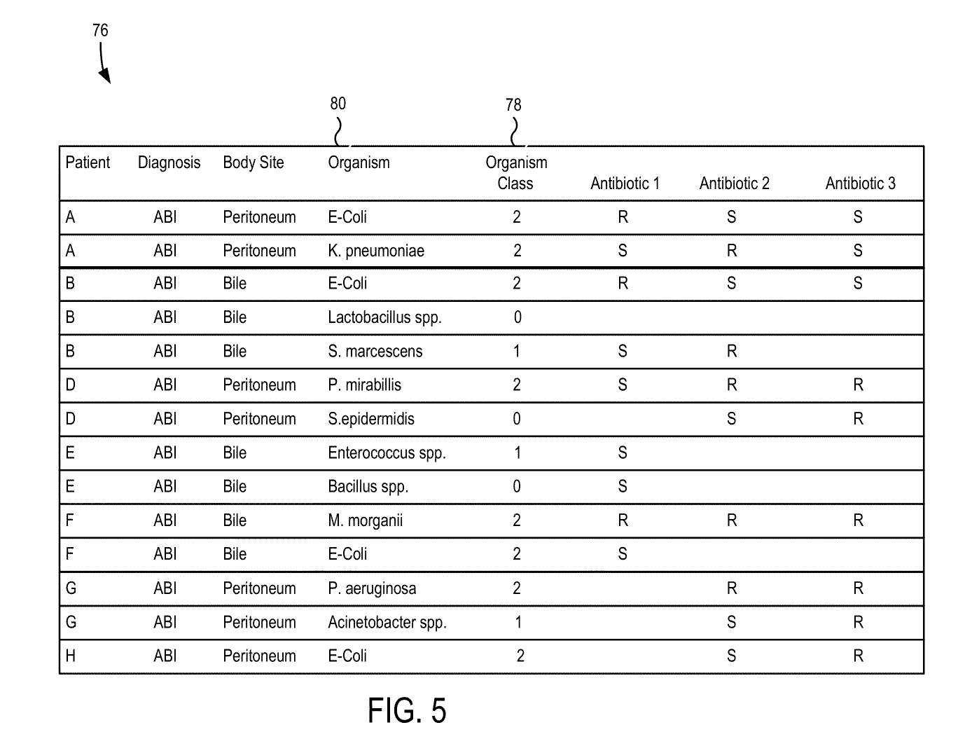

Referring back to FIG. 2, the next step 26 in the illustrative method is to ascribe a weight to each row or record of the dataset acquired in step 22 and filtered in step 24. In this step, as shown in FIG. 5, a numerical classification 78 is given to each row of the dataset 76, according to the type of organism recovered. For organisms such as E. coli and M. morganii that are of particular relevance and/or concern for an abdominal biliary infection, a higher numerical weight is ascribed. In the example shown in FIG. 5, each organism 80 is given a classification value between of 0, 1, or 2, with 2 indicating the highest relevance and/or concern, and 0 indicating the lowest relevance or concern. For example, S. epidermidis recovered from a patient's Peritoneum is not diagnostically significant for purposes of determining the appropriate treatment for ABI. Thus, in the exemplary embodiment being discussed, organisms such as S. epidermidis with a classification value of 0 are disregarded and removed from the dataset 76.

As one skilled in the art will appreciate, the values to be ascribed may vary according to the particular implementation of the present system and method, for example encompassing a larger or smaller range, using non-consecutive values, or using fractions or negative values (in instances where the presence of certain organisms or traits is beneficial toward a particular clinical outcome or recovery). This step 26 may be combined with step 24 and/or may occur in conjunction with the input step 22.

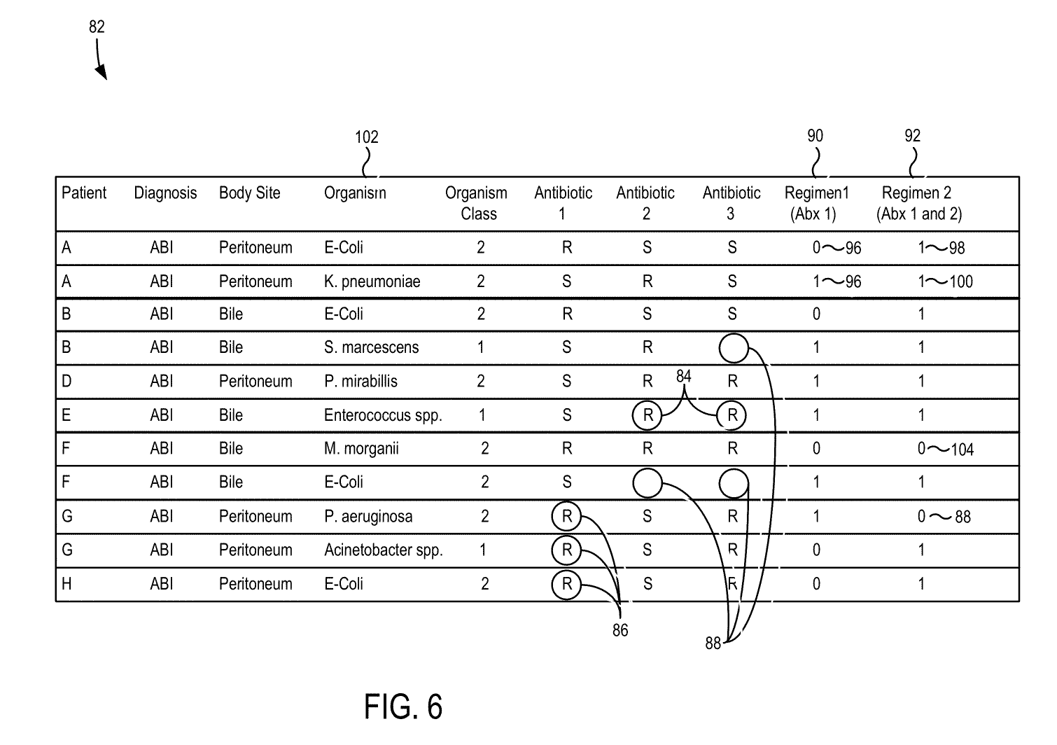

Next, a step 30 is performed in which the outcomes for various treatment regimens (i.e., combinations of individual treatments) are determined, based on known and interpolated efficacies for individual treatments. This step entails first expanding the dataset acquired in step 22 through interpolation to include drug susceptibilities and resistances that were not present in the original data, then identifying all combinations of drugs that would or would not successfully have treated the for each patient. With respect to the illustrative embodiment concerning ABI, a set of known correlations are used to interpolate the resistance or susceptibility of each recovered organism to each relevant antibiotic, where such resistance or susceptibility was not indicated in the data acquired from the locality in step 22. Referring to FIG. 6, a dataset 82 is shown in which drug resistance data 84-86 has been added. The two resistances 84 were added to the dataset 82 according to the known rule that Enterococcus species are always resistant to Antibiotic 2 and Antibiotic 3, even though the original dataset did not indicate that the Enterococcus species recovered from patient E's bile was resistant to Antibiotics 2 and 3. The three resistances 86 were added to the dataset 82 according to the rule that wherever an organism is resistant to Antibiotic 3, the organism will also be resistant to Antibiotic 1. These interpolative rules may be based on relational information such as: known and consistent interactivity between particular antibiotics and particular organisms (e.g., particular bacteria are always susceptible to azithromycin), known correspondences among groups of similar antibiotics (e.g., all amoxicillins and ampicillins will affect certain bacterial similarly), or known correspondences among groups of similar bacteria (e.g., all bacteria within certain groups or classes will have the same or nearly the same antibiotic resistances and susceptibilities). The interpolative rules may also be based on expert opinion and generally accepted assumptions from scientific literature, etc (e.g., E. coli would be considered resistant to vancomycin).

Once all resistances R and susceptibilities S that can be interpolated in this manner have been added to the dataset 82, additional data is then added to the dataset representing what the outcomes (resistance or susceptibility) would have been on an organism-by-organism basis if the antibiotics had been administered in various combinations. By way of illustration, two columns are added to the dataset 82 of FIG. 6 containing information representing what the outcomes 90, 92 would have been had two combinations of antibiotics been administered to each patient represented in the dataset 82. Thus, for column 92, which sets forth a treatment regimen of Antibiotic 1 and Antibiotic 2, the integer “1” is included in rows 98 and 100 to represent that the given organism 102 was susceptible to either Antibiotic 1 or 2, or both. The integer “0” is included in each of rows 104, 106 to represent that the given organism 102 was susceptible to neither Antibiotic 1 nor Antibiotic 2.

Using these integers, the system and method disclosed herein can determine the effectiveness of particular treatment regimens at treating all of the relevant organisms present in patients diagnosed with a particular syndrome. For example, for patient A, the Second Regimen 92 was effective in eliminating both organisms of interest, E. coli and K. pneumoniae, recovered from the only Body Site relevant to a diagnosis of ABI. The Second Regimen 92 was also effective in eliminating all of the organisms of interest in the relevant Body Sites for patients B, D, and E. However, the Second Regimen 92 was only effective in eliminating one of the two organisms of interest for patient F, E. coli, and did not effectively eliminate the other organism of interest, M. morganii. As will be described below, being able to harness such information, regarding which treatment regimens were effective in eliminating all of the organisms pertinent to a given syndrome, provides the ability to use historical medical data to generate recommendations as to the likelihood of numerous treatment regimens effectively treating a subsequent patient's syndrome.

Referring back to FIG. 2, the next step 32 in the illustrative method is to input clinical data for each incidence of the given syndrome of interest, and associate such data, by patient, with the outcomes determined in step 30. The type of clinical data collected may include many common patient characteristics and factors relevant to medical diagnoses, such as age, sex, other demographics, prior surgical procedures, recent prescription history, prior lab results, diagnoses of long-term immuno-compromising conditions like HIV, co-morbidities, admission history, and prior related diagnoses. Not all patient characteristics need be taken into account depending on the syndrome of interest, and easily-accessible electronic data regarding each patient characteristic may not be available at all localities. Thus, during the method 20 for creating the background framework to drive the treatment recommendation tool, the patient characteristics to be obtained and used may be fully customizable, partially customizable, or may be selectable from optional pre-set lists. For example, the patient characteristics may be limited to those characteristics for which a code or other preset indicator already exists in a locality's electronic medical record system. Alternatively, products such as MedMined® (C are Fusion Corp., San Diego Calif.), TheraDoc® (Hospira, Inc., Salt Lake City Utah), SafetySurveillor® (Premier, Inc., Charlotte N.C.), and other available programs for processing and cleaning medical records may be used to process non-standardized or non-coded medical records to obtain standardized patient characteristic information.

In an experiment conducted by the inventors, approximately forty unique patient clinical and demographic characteristics were obtained from a healthcare system's electronic medical record system that were pertinent to an ABI diagnosis, including:

| | UTI Encounters | | ABI Encounters | |
|---|---|---|---|---|
| | Among 6039 | | Among 901 | |
| Patient Characteristics | Patients | | Patients | |
| Age, median (IQR), year | 81 | (69-87) | 64 | (51-76) |
| Admitting Hospital: | | | | |
| Hospital 1 | 2898 | (35%) | 434 | (44%) |
| Hospital2 | 3347 | (41%) | 335 | (34%) |
| Hospital3 | 1718 | (21%) | 195 | (20%) |
| Hospital4 | 269 | (3%) | 32 | (3%) |
| Female | 5887 | (72%) | 496 | (50%) |
| ER or inpatient visit in last 6 | 4529 | (55%) | 465 | (47%) |
| months | | | | |
| Diabetes mellitus | 2451 | (30%) | 173 | (17%) |
| Asthma | 1067 | (13%) | 75 | (8%) |
| CHF | 3143 | (38%) | 172 | (17%) |
| COPD | 1776 | (22%) | 106 | (11%) |
| HIV | 24 | (0.3%) | — | |
| Chronic liver disease | 239 | (3%) | 24 | (2%) |
| Nursing home resident | 1703 | (21%) | 43 | (4%) |
| MDRO cultured in the previous | 747 | (9%) | 44 | (4%) |
| year^{a} | | | | |
| Cancer immunosuppression in last | 206 | (3%) | 26 | (3%) |
| year^{b} | | | | |
| Chronic renal failure^{c} | 1064 | (13%) | 98 | (10%) |
| Number of prior positive urine | 0.95 | (0-18) | — | |
| cultures in previous year, | | | | |
| mean (range) | | | | |
| At least one urine culture positive | 3254 | (40%) | — | |
| in the past year | | | | |
| creatinine > 2 mg/dL on admission | 1377 | (17%) | 11 | (11%) |
| WBC > 11 cells/μL on admission | 3648 | (44%) | 578 | (58%) |
| albumin < 2.5 g/dL on admission | 1258 | (15%) | 241 | (24%) |
| lactate > 2.2 mmol/L on admission | 837 | (10%) | 89 | (9%) |
| In the last 30 days received: | | | | |
| Any antibacterial | 1760 | (21%) | 282 | (28%) |
| TMP-SMX | 157 | (2%) | | |
| Carbapenem | 69 | (1%) | 28 | (3%) |
| Cephalosporin | 657 | (8%) | 119 | (12%) |
| Fluoroquinolone | 790 | (10%) | 104 | (10%) |
| Macrolide | 119 | (1%) | 5 | (1%) |
| Anti-pseudomonal penicillin | 219 | (3%) | 64 | (6%) |
| In the last 30-180 days received: | | | | |
| Any antibacterial | 3270 | (40%) | 304 | (30%) |
| TMP-SMX | 428 | (5%) | | |
| Carbapenem | 176 | (2%) | 29 | (3%) |
| Cephalosporin | 1446 | (18%) | 144 | (14%) |
| Fluoroquinolone | 2077 | (25%) | 154 | (15%) |
| Macrolide | 437 | (5%) | 27 | (3%) |
| Anti-pseudomonal penicillin | 554 | (7%) | 74 | (7%) |

^{a}Defined as a culture positive for Methicillin resistant Staphylococcus aureus, Vancomycin resistant enterococcus, any extended spectrum beta-lactamase, E. coli or Klebsiella resistant to ceftazidime, or a carbapenem/ceftazidime resistant Pseudomonas, Enterobacter, Acinetobacter or Citrobacter in the previous year.
^{b}Defined as a white blood cell count <2 or >50 in the previous year suggestive of cancer or treatment for cancer.
^{c}Defined as a creatinine greater than 2 in the previous 6 months

In an alternative embodiment, this step 32 of collecting patient characteristic data may be performed prior to or in conjunction with steps 24 and 26 of the illustrative method 20. In such embodiment, each patient's clinical data may be used in determining which organisms are of significance to the syndrome of interest and how to weight the organisms that are significant. For example, if a patient is immunocompromised, certain organisms that may have otherwise been considered irrelevant may be relevant for that patient. Or, if a patient has recently taken an antibiotic that was thought to consistently eliminate a particular microorganism that is nonetheless still present in positive cultures from that patient, it may be desirable to consider that microorganism to be more relevant.

Referring again to FIG. 2, the next step 34 in the illustrative method is to statistically correlate the treatment regimen outcomes determined in step 30 for each incidence of the syndrome of interest with the patient demographic and clinical data obtained in step 32 of the patients that presented with the incidences. These statistical correlations can be used to determine the influence each patient-specific and locality-specific characteristic has on the likelihood that a given treatment regimen would “cover” all infecting organisms for a syndrome of interest. In other words, the correlations can be used to determine the extent to which the presence of each characteristic influences the probability that a given regimen will successfully treat the syndrome. As discussed above, this approach is distinct from prior systems, which were organism-specific, not syndrome-specific or patient-specific, and provided information only as to whether a drug would eliminate an individual organism.

To generate these statistical correlations, multivariable logistic regressions are performed for each treatment regimen (e.g., 90, 92), for the syndrome of interest. It is contemplated that other statistical and machine learning tools are contemplated to determine the association between patient characteristics and treatment outcomes. The outcome of interest in the regressions is “coverage” (i.e., whether each recovered organism in a case was susceptible to at least one agent in the treatment regimen). The independent variables of the regressions are the patient characteristics obtained in step 32, using logical “1” or “0” to represent, e.g., whether a patient is female, has been hospitalized in the last week, has recently undergone a surgical procedure, etc., or using actual numerical values for clinical characteristics such as the number of hospitalizations in the previous six months. The selection of which variables to use may be pre-set for each syndrome of interest, or may be automatically selected based on likely statistical significance. For example, a vendor of the present system and method may empirically determine and pre-set the characteristics most likely to be statistically significant to the outcome of interest for a particular syndrome. Alternatively, certain embodiments of the present invention may analyze the data collected and interpolated in steps 22-32 of the method 20 of FIG. 2, and select variables that, for example, do not have a narrow value distribution, do not have values suggesting inconsistent or inaccurate data in the medical records, and/or do not have an unreliably small data set. In any case, the selected variables to be used will preferably be the same across the regressions for each treatment regimen, so as to ensure maximum model fit and to allow comparability of the regression models derived for each treatment regimen. The logistic regressions generate final regression equations that model each treatment regimen. The equations, in human-readable format, would resemble the following:

$$P = \frac{1}{1 + exp [ - X ]}$$

Where X=“Intercept”+

(“MDRO in prior 1 year” coefficient x 1(if yes) or 0(if no) )+

(“Nursing home resident” coefficient x 1(if yes) or 0(if no))+

Only one of the following age variables:

(“Age≦25” coefficient x 1(if yes) or 0(if no))

(“Age 26-64” coefficient x 1(if yes) or 0(if no))

Age >64, 0 +

Only one of the following hospitalization variables

No recent hospitalizations, 0

(“1 recent hospitalization” coefficient x 1(if yes) or 0(if no))

(“≧2 recent hospitalization” coefficient x 1(if yes) or 0(if no))+

(“≧1 recent emergency room visit” coefficient x 1(if yes) or 0(if no))+

(“Carbapenem in the last 30 days” coefficient x 1(if yes) or 0(if no))+

(“Carbapenem in the last 30-180 days” coefficient x 1(if yes) or 0(if no))+

(“Cephalosporin in the last 30 days” coefficient x 1(if yes) or 0(if no))+

(“Cephalosporin in the last 30-180 days” coefficient x 1(if yes) or 0(if no))+

(“Fluoroquinolone in the last 30 days” coefficient x 1(if yes) or 0(if no))+

(“Fluoroquinolone in the last 30-180 days” coefficient x 1(if yes) or 0(if no))+

(“Macrolide in the last 30 days” coefficient x 1(if yes) or 0(if no))+

(“Macrolide in the last 30-180 days” coefficient x 1(if yes) or 0(if no))+

(“anti-pseudomonal penicillin” in the last 30 days coefficient x 1(if yes) or 0(if no))+

(“anti-pseudomonal penicillin” in the last 30-180 days coefficient x 1(if yes) or 0(if no))+

(“History of asthma” coefficient x 1(if yes) or 0(if no))+

(“History of Chronic obstructive pulmonary disease” coefficient x 1(if yes) or 0(if no))+

(“History of Congestive heart failure” coefficient x 1(if yes) or 0(if no))+

(“History of Diabetes” coefficient x 1(if yes) or 0(if no))+

(“History of Liver Disease” coefficient x 1(if yes) or 0(if no))+

(“History of Renal Disease” coefficient x 1(if yes) or 0(if no))+

(“Cancer immunosuppression” coefficient x 1(if yes) or 0(if no))+

(“Lactate >2.2 mmol/L” coefficient x 1(if yes) or 0(if no))+

(“Creatinine>2 mg/dL” coefficient x 1(if yes) or 0(if no))+

(“Albumin <2.5 g/dL” coefficient x 1(if yes) or 0(if no))+

(“white blood cell count >11 ” coefficient x 1(if yes) or 0(if no))+

Only one of the following site variables

Hospital 1, 0

“Hospital 2” coefficient x 1(if yes) or 0(if no))

“Hospital 3” coefficient x 1(if yes) or 0(if no))

“Hosital 4” coefficient x 1(if yes) or 0(if no))

Referring again to FIG. 2, once the final regression equations have been validated and tested for goodness-of-fit, they are fed to a guidance engine for use as models in driving a therapeutic recommendation tool, such as shown and described with respect to FIG. 7. Once these models have been fed to the guidance engine, the framework for the system and method disclosed herein will have been generated, and the system can become operational. At this point, a clinician or other user can input a current patient's relevant characteristics and the guidance engine, using the models determined in step 34, will plug the characteristics into the models determined in step 34 and provide probabilities via a therapeutic recommendation tool that a given regimen would cover that particular patient's syndrome. It is noted that the above-mentioned “user”+0 may also be an electronic medical record system that is configured to directly communicate these patient characteristics to a server performing the calculations to spare the clinician data entry work. While operational, the guidance engine 38 can also continually perform a check 38 to determine whether new incidence data has been entered into an EMR system. If so, the data is collected 22, and the method 22 for generating the background framework is re-run.

With certain variations, the above-described method 20 may be employed to generate guidance engines for other syndromes beyond ABI. For other infections, such as urinary tract infections or respiratory infections, the only major differences would be in the data inputting and filtering steps 22-24 and the weighting and interpolating steps 26-28. The Body Sites of interest could, of course, be different for each infection, and the particular weighting criteria could differ as well (e.g., a certain microorganism may be highly relevant in a surgical wound infection, but not relevant to a respiratory infection). When the syndrome of interest is a cancer, the collected data may indicate various mutations, types of tumors or cancerous cells, tumor sizes, or simply locations of tumors, rather than microorganisms. The various applicable radiation, surgical, and/or chemotherapy treatments would be included rather than antibiotics, with the outcome of interest being substantial remission. The method 20 similarly extends to other common syndromes that are typically treated using regimens of multiple drugs and/or procedures.

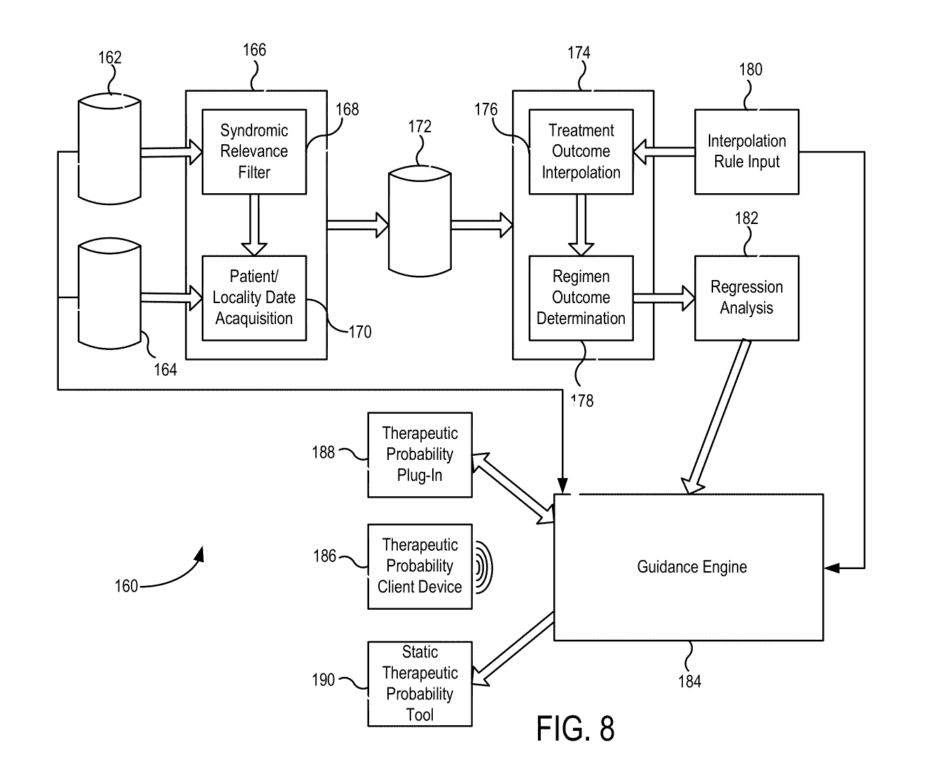

Referring now to FIG. 8, a functional block diagram 160 is shown, depicting an exemplary physical implementation of the system and method disclosed herein. Notwithstanding the organization and interconnectivity shown in the Figure, one skilled in the art will appreciate that the functional modules shown in FIG. 8 could all be subsumed within a single electronic medical record server located within a healthcare system, could be partially implemented by a local server and partially by a remote vendor server, or could be implemented completely by a remote vendor server.

In the depicted embodiment, data is acquired from both a laboratory information database 162 and an electronic medical record database 164 and communicated to a separate preliminary data processing stage 166. The preliminary data processing stage 166 includes two modules, a syndromic relevance filter 168 and a patient/locality-specific data acquisition module 170, which in combination may perform steps 2, 24, and 32 of the method 20 of FIG. 2. The output of the preliminary data processing stage 166 is thus a historical incidence dataset, such as described above with respect to FIG. 2 and as illustrated in FIG. 5. As one skilled in the art will appreciate, all or a portion of the preliminary data processing stage 166 may be implemented remotely at a vendor location or may be implemented locally on a healthcare institution's data warehouse or data archive server. Preferably, the filtering and data acquisition modules are at least partially implemented and executed locally at a healthcare institution to eliminate logistical problems arising from the transfer of massive amounts of data. Specifically, healthcare institutions may not have the processing capacity or network bandwidth to reasonably transfer large, unfiltered medical and laboratory databases. In any case, the historical incidence dataset 172 output by the preliminary processing stage 166 is of a far more manageable size for continued processing than the raw medical and laboratory databases 162, 164.

The historical incidence dataset 172 is further processed by a more complex post-processing stage 174. The post-processing stage 174 carries out steps 26, 28, and 30 of the method 20 of FIG. 2. The treatment outcome interpolation module 176 is thus connected to receive user input 180 comprising the criteria or rules by which the post-processing stage 174 is to fill-in missing resistance/susceptibility information and rank the significance of recovered microorganisms. Given the data interpolated according to the user input 180, resistance and susceptibility outcomes on a treatment regimen basis are determined. The post-processing stage 174 is preferably implemented and executed on a remote vendor server to allow for ease of updating the criteria supplied via user input. Alternatively, the post-processing stage 174 may be implemented locally on a healthcare system's server to allow for more direct control over which assumptions and other interpolative rules are to be used. The output of the post-processing stage is then run through regression analyses for each identified treatment regimen. The regression analysis module 182 may be executed locally at a healthcare system or remotely at a vendor site. Given the computing power necessary to perform regression analyses on such large datasets, the regression analysis module is preferably performed on a server or distributed network.

The models output by the regression analysis module are fed to a guidance engine 184, which is preferably a stand-alone server. On start-up, the guidance engine reads the output (regression coefficients) of the regression analysis module 182 once and waits for either user input or notification of an update from the interpolation rule input 180 or the laboratory and medical record databases 162, 164. The clients of the guidance engine are various implementations of a therapeutic probability tool, such as described above with respect to FIG. 7. In one embodiment, a therapeutic probability tool 186 is implemented as a website or other user-interface on a workstation within the healthcare institution (such as a workstation in an inpatient room or outpatient exam room), in a manner similar to that shown in FIG. 7. When a syndrome of interest and patient-specific criteria are selected, such selections are communicated to the guidance engine 184 via, for example, optionally encrypted communication over network sockets (e.g. database connection over SSL encryption layer) (when the guidance engine is implemented at a remote vendor location) or simply over a healthcare institution's local area network (when the guidance engine is implemented on a local server). The guidance engine 184 processes the selections and synthesizes them as inputs to the treatment regimen models obtained from the regression analysis module 182, and determines the resultant probabilities for each relevant treatment regimen. The guidance engine then sorts and formats the output to be set back to the therapeutic probability tool 186.

In another embodiment, a therapeutic probability tool 188 may be implemented as a plug-in to an existing electronic medical records software suite. In that case, a clinician need only enter the diagnosed syndrome and the probability tool 188, already having access to the patient's demographic and prior clinical characteristics by virtue of being part of the EMR software, can simply communicate the appropriate characteristic data to the guidance engine 184 without requiring a user to manually select and input the characteristics.

In a third embodiment, a static therapeutic probability tool 190 is implemented as a software package to run entirely on a stand-alone computer. In this embodiment, the guidance engine 184 provides a user with a software download that includes an executable program which locally uses the regression models to determine treatment regimen probabilities. In this instance, the probability calculations will not be dynamically updated by the guidance engine through connection to the healthcare system's laboratory and medical record databases. This implementation may, for example, provide a general practitioner or small clinic with regression models developed from incidence data in the same geographic region as the practitioner or clinic, but which was obtained from other institutions.

The guidance engine 184 is further configured to receive notifications from the interpolation rule input module 180 and the laboratory and medical record systems 162, 164. Upon receiving a notification that new prior incidence data or new interpolation rules are available, the guidance engine acquires new regression models from the regression analysis module 182, taking into account the new information.

The present invention has been described in terms of one or more preferred embodiments, and it should be appreciated that many equivalents, alternatives, variations, and modifications, aside from those expressly stated, are possible and within the scope of the invention.

1. A treatment regimen guidance system comprising:
an interface tool configured to receive a diagnosis for a current patient and arranged to communicate the diagnosis and demographic and clinical information regarding the current patient;
a guidance engine configured to receive the diagnosis and the demographic and clinical information regarding the current patient;
wherein the guidance engine is configured to calculate a treatment regimen outcome probability using the demographic and clinical information and at least one predictive model; and
wherein the interface tool is configured to display to a user an indication of the treatment regimen outcome probability.

2. The treatment regimen guidance system of claim 1 wherein the interface tool comprises at least one of an electronic medical record system plug-in and a network-based user interface.

3. The treatment regimen guidance system of claim 1 wherein the guidance engine comprises a server located remotely from a healthcare system.

4. The treatment regimen guidance system of claim 1 further comprising a processor configured to acquire data from at least one of a laboratory information system and an electronic medical records system, wherein the data consists essentially of data represented by the predictive model.

5. The treatment regimen guidance system of claim 4 wherein the processor is located within a healthcare system treating the current patient.

6. The treatment regimen guidance system of claim 4 further comprising an interpolation module configured to derive additional data missing from the data acquired by the processor from the at least one laboratory information system and electronic medical records system.

7. The treatment regimen guidance system of claim 1 wherein the at least one predictive model includes a regression model based on a dataset consisting essentially of data regarding prior incidences of the diagnosis within at least one of a healthcare system and a geographic region in which the current patient is located.

8. A computer-readable storage medium having stored thereon a computer program that, when executed by a computer processor, causes the computer processor to:
receive patient characteristic data for a current patient;
receive a diagnosis for the current patient;
identify, based on weighted patient-specific and syndrome-specific data for previous patients, at least one treatment regimen that could cover the diagnosis for the subject patient;
calculate a probability that the at least one treatment regimen will successfully treat the diagnosis for the subject patient; and
generate a report indicating the at least one treatment regimen to a user.

9. The storage medium of claim 8 wherein the processor is further caused to extract patient demographic data and prior clinical data for the current patient from the patient characteristic data.

10. The storage medium of claim 9 wherein the processor is further caused to calculate the probability using the patient demographic data and prior clinical data as inputs to at least one treatment regimen model.

11. The storage medium of claim 10 wherein the processor is further caused to generate the at least one treatment regimen model to using a logistic regression equation determined based on the weighted patient-specific and syndrome-specific data for previous patients.

12. The storage medium of claim 8 wherein the processor is further caused to generate a list of treatment regimens and a probability of each treatment regimen covering the diagnosis for the subject patient as part of the report.

13. The storage medium of claim 8 wherein the processor is further caused to access the patient characteristic data from an electronic medical record system plug-in running on a processing unit at a healthcare facility.

14. The storage medium of claim 8 wherein the at least one treatment regimen comprises a combination antibiotics.

15. The storage medium of claim 8 wherein a portion of the syndrome-specific data is interpolated data derived from user-defined criteria.

16. A computer-readable storage medium having stored thereon a computer program that, when executed by a computer processor, causes the computer processor to implement a treatment regimen guidance system by:
obtaining and storing characteristics regarding prior incidences of a syndrome of interest within a locality of interest via an electronic medical record system;
determining outcomes of combinations of treatments on the syndrome of interest;
generating models indicating influences of the characteristics on the outcomes of the combinations of treatments; and
storing the models for use in determining probabilities that a combination of treatments will successfully treat the syndrome of interest in a patient.
